(19) United States
(12) Patent Application Publication
(10) Pub. No.: US 2017/0205747 A1
(43) Pub. Date: Jul. 20, 2017

(54) IMAGE HEATING APPARATUS

(71) Applicant: CANON KABUSHIKI KAISHA, Tokyo (JP)

(72) Inventor: Takeshi Kozuma, Abiko-shi (JP)

(21) Appl. No.: 15/479,501

(22) Filed: Apr. 5, 2017

Related U.S. Application Data
(63) Continuation of application No. PCT/JP2015/079105, filed on Oct. 7, 2015.

(30) Foreign Application Priority Data
Oct. 8, 2014 (JP) 2014-207005

(51) Int. Cl. G03G 15/20

(52) U.S. Cl. CPC G03G 15/2085

(57) ABSTRACT

An image heating apparatus includes first and second rotatable members for forming a nip for heating a toner image on a sheet; a compressor; an air nozzle for blowing air, generated by the compressor, on the first rotatable member; and a supplying mechanism for supplying air from the compressor to the air nozzle, the supplying mechanism including a plurality of air tubes and a plurality of clamps for fixing the plurality of air tubes, wherein a pressure at which the air tube is unclamped is lower only at a predetermined portion of the clamped portions than the other portions by 20% or more.

### TECHNICAL FIELD

The present invention relates to an image heating apparatus for heating a toner image on a sheet.

### BACKGROUND ART

An image forming apparatus in which the toner image is formed on a recording material (sheet) and the recording material on which the toner image is formed is heated and pressed by a fixing device (image heating apparatus) and an image is fixed on the recording material has been widely used. In such a fixing device, at a nip formed by a pair of rotatable members, a fixing process is carried out.

In the case where the recording material is thin and low in rigidity, the recording material is not readily separated from the rotatable members. For this reason, a proposed that an air nozzle is provided in the neighborhood of the rotatable members and the recording material is forcedly separated from the rotatable members by blowing air, supplied from a compressor, from the air nozzle onto the recording material has been made (Japanese Laid-Open Patent Application SHO 60-247672, Japanese Laid-Open Patent Application 2007-94327).

In an air supplying path from the compressor to the air nozzle, many air tubes are provided for being connected between devices. These air tubes are fixed by clamps in a state in which the air tubes are inserted into the devices, and during operation, are constituted so as not be unclamped when the air tubes are in a normal condition.

On the other hand, in the case where a pressure in the air supplying path is excessively increased by out-of-order of the device, there is a liability that the air tube is unclamped against a clamp fastening force.

In such a case, a recovery operation is to be carried out, but when all of the portions where many air tubes are connected are checked thoroughly, the recovery operation requires a long time.

### SUMMARY OF THE INVENTION

According to an aspect of the present invention, there is provided an image heating apparatus comprising: first and second rotatable members for forming a nip for heating a toner image on a sheet; a compressor; an air nozzle for blowing air, generated by the compressor, on the first rotatable member; and a supplying mechanism for supplying air from the compressor to the air nozzle, the supplying mechanism including a plurality of air tubes and a plurality of clamps for fixing the plurality of air tubes, wherein a pressure at which the air tube is unclamped is lower only at a predetermined portion of the clamped portions than the other portions by 20% or more.

### BRIEF DESCRIPTION OF THE DRAWINGS

FIG. 1 is an illustration of a structure of an image forming apparatus.

FIG. 2 is an illustration of a structure of a fixing device.

FIG. 3 is an illustration of a high-pressure air path of the image forming apparatus.

FIG. 4 is an illustration of an arrangement of air tubes.

FIG. 5 includes illustrations of an air tube mounting structure.

FIG. 6 is an illustration of an unclamping strength test of the air tube.

FIG. 7 is an illustration of a retaining member for a tube clamp.

FIG. 8 is an illustration of a connected portion of an air tube in Embodiment 2.

FIG. 9 is an illustration of a high-pressure air path in Embodiment 4.

### EMBODIMENTS FOR CARRYING OUT THE INVENTION

In the following, with reference to the drawings, an embodiment of the present invention will be described specifically.

### Embodiment 1

### Image Forming Apparatus

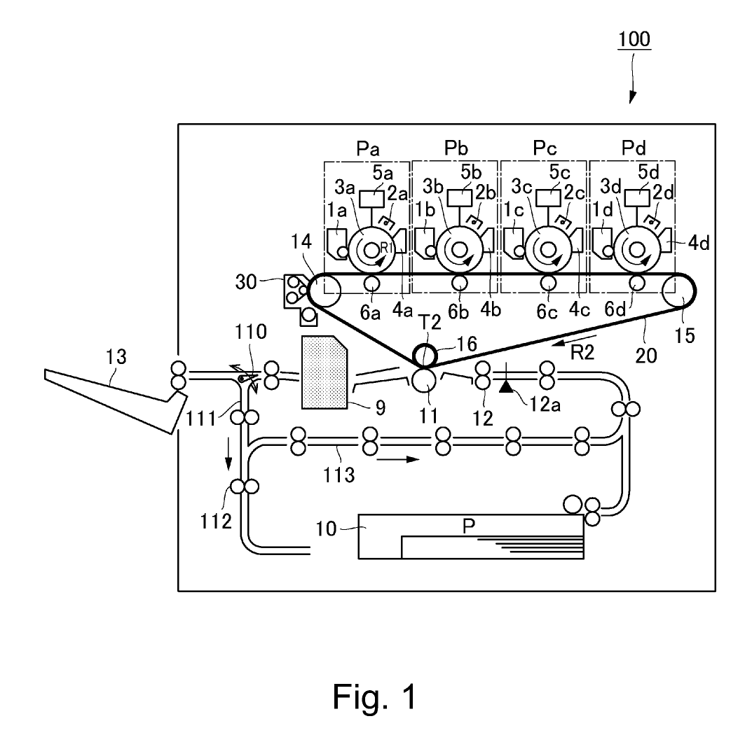

FIG. 1 is an illustration of a structure of an image forming apparatus. As shown in FIG. 1, an image forming apparatus 100 is a tandem-type full-color printer of an intermediary transfer type in which image forming apparatus Pa, Pb, Pc, Pd of yellow, magenta, cyan, black are arranged along an intermediary transfer belt 20.

At the image forming portion Pa, a yellow toner image is formed on a photosensitive drum 3a and is primary-transferred onto the intermediary transfer belt 20. At the image forming portion Pb, a magenta toner image is formed on a photosensitive drum 3b and is primary-transferred onto the intermediary transfer belt 20. At the image forming portion Pc and Pd, a cyan toner image and a black toner image on the photosensitive drums 3c and 3d, respectively, and are primary-transferred onto the intermediary transfer belt 20.

A recording material (sheet) P is taken out one by one from a cassette 10 and is on stand-by at a registration roller 12. The recording material P is fed by the registration roller 12 to a secondary transfer portion T2 in timing with the toner images on the intermediary transfer belt 20, and the toner images are secondary-transferred onto the recording material P. The recording material P on which the toner images of the four colors are secondary-transferred is fed to a fixing device 9 and is heated and pressed by the fixing device 9, so that an image is fixed on a surface of the recording material P, and thereafter is discharged on a tray 13 outside the apparatus.

In double-side printing, the recording material on which the images are fixed at a front surface thereof by the fixing device 9 is sent into a reverse feeding path and is switched back, and then passes transfer a feeding path 113 in a state in which a leading end and a trailing end are reversed and in which the front surface and a back surface are reversed, and is on stand-by at the registration roller 12. Then, the recording material is fed again to the secondary transfer portion T2, where the toner images are transferred onto the back surface of the recording material and are fixed on the back surface of the recording material by the fixing device 9, and thereafter, the recording material is discharged on the tray 13 at an outer portion of the apparatus (printer).

### Image Forming Portion

The image forming portions Pa, Pb, Pc, Pd have substantially the same constitution except that the colors of the toners used in developing devices 1a, 1b, 1c, 1d are yellow, magenta, cyan, black which are different from each other. In the following, the image forming portion Pa for yellow will be described, and redundant description relating to other image forming portions Pb, Pc, Pd will be omitted.

At the image forming portion Pa, at a periphery of the photosensitive drum 3a, a corona charger 2a, an exposure device 5a, the developing device 1a, a transfer roller 6a and a drum cleaning device 4a are provided.

The corona charger 2a electrically charges a surface of the photosensitive drum 3a to a uniform potential. The exposure device 5a writes the electrostatic image for the image on the photosensitive drum 3a by scanning the photosensitive drum surface with a laser beam. The developing device 1a develops the electrostatic image into the toner image on the photosensitive drum 3a by transferring the toner on the electrostatic image on the photosensitive drum 3a. The transfer roller 6a primary-transfers the toner image from the photosensitive drum 3a onto the intermediary transfer belt 20 under application of a voltage of an opposite polarity to a charge polarity of the toner.

The intermediary transfer belt 20 is extended around and supported by a tension roller 14, a driving roller 15 and an opposing roller 16, and is driven by the driving roller 15, so that the intermediary transfer belt 20 rotates in an arrow direction. A secondary transfer roller 11 press-contacts the intermediary transfer belt 20 supported by the opposing roller 16 and forms the secondary transfer portion T2. A belt cleaning device 30 rubs the intermediary transfer belt 20 with a cleaning web and thus removes a transfer residual toner passed transfer the secondary transfer portion T2.

### Fixing Device

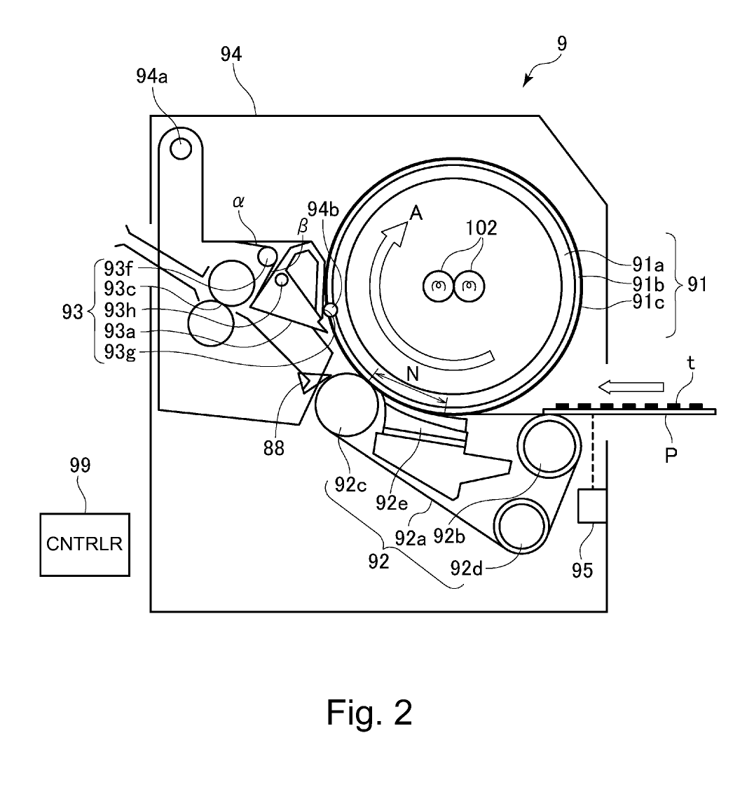

FIG. 2 is an illustration of a structure of the fixing device functioning as an image heating apparatus. As shown in FIG. 2, the recording material P on which the toner image is transferred is fed by a pressing belt 92a and is introduced into a fixing nip N, and is nipped and fed by a fixing roller 91 and a pressing unit 92. The toner image on the recording material P is heated and pressed in a process of passing through the fixing nip N, so that the toner image is fixed on the surface of the recording material. The fixing device 9 causes the pressing belt unit 92 to press-contact the fixing roller 91, so that the fixing nip is formed between the fixing roller 91 and the pressing belt unit 92. The fixing roller 91 and the pressing belt unit 92 which are an example of pair of rotatable members heat, the recording material on which the toner image is carried.

The fixing roller 91 includes a core metal 91a formed of a cylindrical metal, a heat-resistant elastic layer 91b disposed in an outer side of the core metal 91a, and a parting layer 91c of a heat-resistant fluorine-containing resin material coated on an outer peripheral surface of the elastic layer 91b in order to improve a toner parting property. The core metal 91a is an aluminum-mode cylindrical material of 77 mm in outer diameter, 6 mm in thickness and 350 mm in length. The elastic layer 91b is a 1.5 mm-thick silicone rubber of 20 degrees in JIS-A hardness. The parting layer 91c is a 50 μm-thick PFA tube.

The fixing roller 91 is rotatably supported at both end portions by a fixing device frame 94, and is rotationally driven at a predetermined speed (e.g., 500 mm/s in peripheral speed) in an arrow A direction by an unshown driving source.

Inside the core metal 91a, a halogen heater 102 of 1200 W in (normal) related electric power and heats the fixing roller 91 from the inside of the fixing roller 91. Electric power supply of the halogen heater 102 is controlled by an unshown temperature control circuit so that a surface temperature of the fixing roller 91 measured by an unshown thermistor maintains a target temperature for temperature adjustment.

The pressing belt 92a is an endless belt of φ70 mm in outer diameter such that a 200 μm-thick elastic layer of a silicone rubber is disposed on a 100 μm-thick base layer formed of polyimide.

The pressing belt 92a is stretched by an entrance roller (driving roller) 92b, a separation roller 92c, a steering roller 92d and a photosensitive drum pad 92e. The pressing belt 92a is rotationally driven by a driving force inputted from an unshown driving source into the separation roller 92c.

The separation roller 92c presses the pressing belt 92a toward the fixing roller 91 by being urged at both end portions by an unshown pressing mechanism (spring). The pressing pad 92e carries out pressing of 490 N (50 kgf) in total.

The pressing pad 92e presses the pressing belt 92a toward the fixing roller 91 by being urged at both end portions by an unshown pressing mechanism (spring). The separation roller 92c carries out pressing of 490 N (50 kgf) in total.

### Separation of Recording Material

The fixing device 9 nips and feeds the recording material, on which the toner image is carried, by the fixing roller 91 and the pressing belt 92a, so that the image is formed on the recording material P. In the fixing device 9, an unfixed toner image formed on the recording material P directly contacts the surface of the fixing roller 91, and therefore there is a possibility that the recording material P sticks to the fixing roller 91 due to viscosity of melted toner and is moved without being peeled off from the fixing roller 91. By this, there is a possibility that a jam of the recording material is caused.

The fixing device 9 peels off the recording material P sticking to the pressing belt 92a by causing a separation claw 88, formed of a heat-resistant resin material, to contact and rub the surface of the pressing belt 92a. On the separation claw 88, there is a need to exert a small pressing force in order to be closely contacted to the pressing belt 92a.

However, in the case where the small pressing force is exerted on the separation claw 88 by causing the separation claw 88 to contact the fixing roller 91, a peripheral surface of the fixing roller 91 sliding with a free end of the separation claw 88 is locally abraded. When a hard foreign matter is deposited on the separation claw 88, there is a possibility that the surface layer of the fixing roller 91 is damaged.

Further, in the case of the recording material such as thin paper small in weight per unit area, there is a possibility that a leading end portion of the recording material runs against the separation claw 88 and is damaged, and generates creases, folds or breakage. In order to solve such problems, in Embodiment 1, compressed air is blown onto the leading end of the recording material P on the fixing roller 91, so that the recording material P is peeled off.

### Discharging Unit

A discharging unit 92 is disposed downstream of the fixing nip N with respect to a recording material feeding direction. The discharging unit 93 separates the recording material P, passed through the fixing nip N, from the fixing roller 91 by high-pressure air blast by an air nozzle 93a, and discharges the recording material P to an outside of the fixing device 9 by a feeding roller pair 93c.

The air nozzle 93a blows high-pressure air onto the leading end of the recording material P, on the fixing roller 91, after passing through the fixing nip N, and peels off the recording material P from the fixing roller 91. The feeding roller pair 93c nips and feeds the peeled recording material P and discharges the recording material P to the outside of the fixing device 9.

The discharging unit 93 is rotatable about a rotation center 94a of the fixing device frame 94. The discharging unit 93 is rotatable between a disposing position where the discharging unit 93 is disposed when the fixing device 9 performs a fixing operation and a retracted position where the discharging unit 93 is rotated and retracted from the fixing roller 91 when the recording material P remaining in the fixing device 9 is removed during jam clearance. The discharging unit 93 is rotated and raised to the retracted position, whereby a space ensuring an unobstructed view from a downstream side is formed in the downstream side of the fixing nip N, so that the recording material P which has not been discharged can be discharged.

The air nozzle 93a is supported by the discharging unit 93 rotatably about a nozzle rotation center 93h, and is pressed by a movable end β of a helical torsion coil spring with a fixed end α. To the fixing device frame 94, a nozzle positioning pin 94b is fixed. When the discharging unit 93 disposed in the fixing device 9, an abutting surface 93g of the air nozzle 93a abuts against the nozzle positioning pin 94b, so that the air nozzle 93a is positioned relative to the fixing roller 91.

In the case where a weight per unit area of the recording material P is 128 g/m² or less, a controller 99 discriminates that peeling by compressed air is needed. When the recording material P is sent into the fixing device 9, a recording material detecting sensor 95 detects the leading end of the recording material P. The controller 99 causes the air nozzle 93a to blow the compressed air onto the leading end of the recording material P on the fixing roller 91 at a speed of about 300 m/sec after a lapse of a predetermined time on the basis of timing when the recording material detecting sensor 95 detected the leading end of the recording material P, and peels off the recording material P from the fixing roller 91.

### High-Pressure Air Path

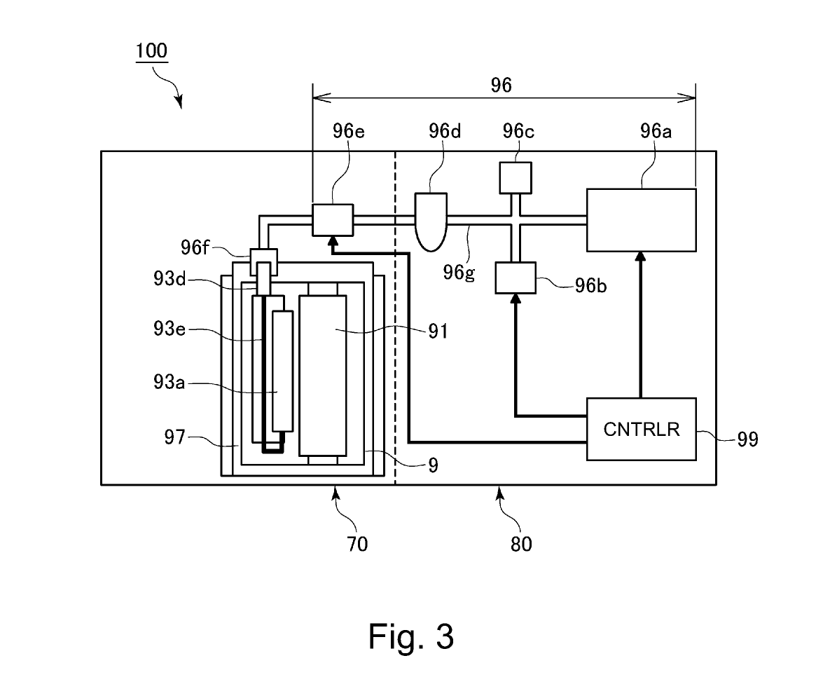

FIG. 3 is an illustration of a high-pressure air path of the image forming apparatus. As shown in FIG. 3, the fixing device 9 in which the discharging unit 93 is mounted is disposed by being shifted toward a front (surface) side of the image forming apparatus 100. A high-pressure air path 96 by an air supplying mechanism for supplying the compressed air to the discharging unit 93 is disposed by being shifted toward a rear (surface) side of the image forming apparatus 100.

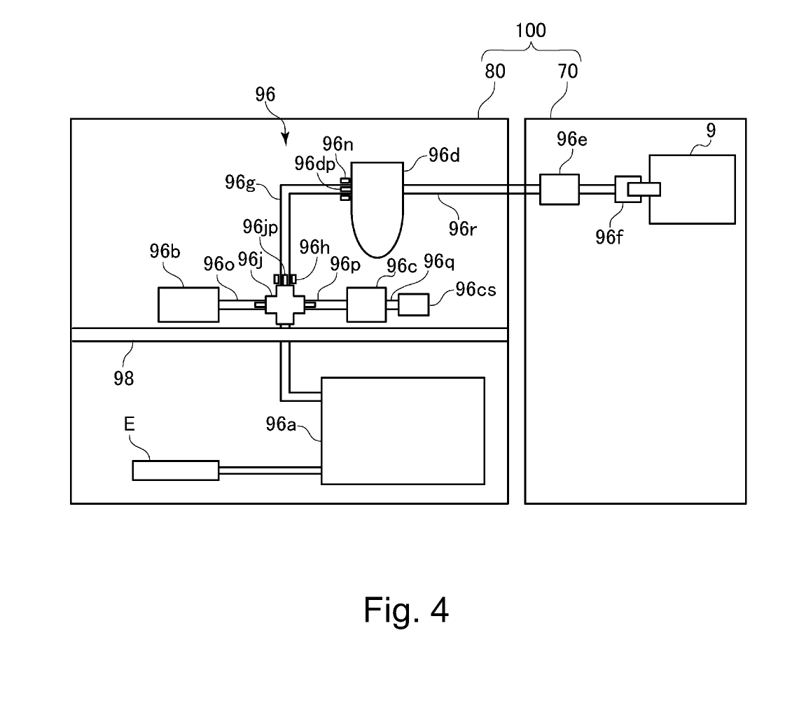

As shown in FIG. 3, in the high-pressure air path 96 by the air supplying mechanism for supplying the air from a compressor 96a to the air nozzle 93a, at least a solenoid (electromagnetic) valve 96e functioning as a pressure limiting mechanism and a pressure adjusting valve 96c are provided. The compressor 96a generates high-pressure air blown by the air nozzle 93a. The air compressor 96a is provided in a casing of the image forming apparatus 100 and compresses ambient air and supplies the compressed air to the high-pressure air path 96. As shown in FIG. 4, a joint part (component) 96j which is an example of a relay member relays an air tube 96g.

A pressure-heating solenoid valve 96b which is also the pressure limiting mechanism discharges the high-pressure air, in the high-pressure air path 96, to the outside. The controller 99 actuates the pressure-heating solenoid valve 96b during actuation of the compressor 96a and lowers the pressure in the high-pressure air path 96 to atmospheric pressure, so that an actuating torque of the compressor 96a is decreased to a small value. An air filter 96d separates and discharges a drain, water, dirt and dust contained in the high-pressure air discharged by the air compressor 96a.

The solenoid valve 93e switches supply and block of the high-pressure air supplied to the air nozzle 93a. The solenoid valve 93e is connected with a main assembly-side coupler 96f by the air tube 96g and sends the high-pressure air, in the high-pressure air path 96, to the air nozzle 93a. The air nozzle 93a which is an example of an air nozzle is capable of blowing the high-pressure air onto the fixing roller 91. The air nozzle 93a blows the high-pressure air onto the leading end of the recording material P and separates the recording material P from the fixing roller 91. The main assembly-side coupler 96f is detachably connected to a fixing-side coupler 93d. The high-pressure air supplied from the main assembly-side coupler 96f to the discharging unit 93 through the fixing-side coupler 93d is blown from the air nozzle 93a onto the fixing roller 91.

The coupler 99 actuates the air compressor 96a and thereafter closes the pressure-heating solenoid valve 96b. Thereafter, compressed air with a pressure P2 adjusted by the pressure adjusting valve 96c is accumulated in the high-pressure air path 96 from the compressor 96s to the solenoid valve 96e.

The pressure adjusting valve 96c regulates (adjusts) the pressure of the high-pressure air supplied to the air nozzle 93a to a first pressure P2. The pressure adjusting valve 96c discharges the high-pressure air, in the high-pressure air path 96, to the outside air at the pressure P2 when the pressure in the high-pressure air path 96 reaches the pressure P2, so that the pressure adjusting valve 96c maintains the pressure, in the high-pressure air path 96 ranging to the solenoid valve 96e, at the pressure P2. The solenoid valve 96e is adjusted so that the pressure P2 is about 0.3 MPa.

The controller 99 actuates the solenoid valve 96e so that the recording material is separated from the fixing roller 91. The controller 99 turns on the solenoid valve 96e immediately before the leading end of the recording material reaches a blowing position on the fixing roller 91, and starts blowing of the high-pressure air, accumulated in the high-pressure air path 96 and having the pressure P2, onto the leading end of the recording material. Thereafter the supply of the high-pressure air by the compressor 96a cannot catch up with an amount of flow from the air nozzle 93a, so that blowing pressure of the high-pressure air in the high-pressure air path 96 drastically lowers. The controller 99 turns off the solenoid valve 96e at a portion of about ⅓ of a length of the recording material P with respect to the feeding direction and accumulates the high-pressure air with the pressure Ps in the high-pressure air path, and prepares for a leading end of a subsequent recording material P.

### Mounting Structure of Air Tube

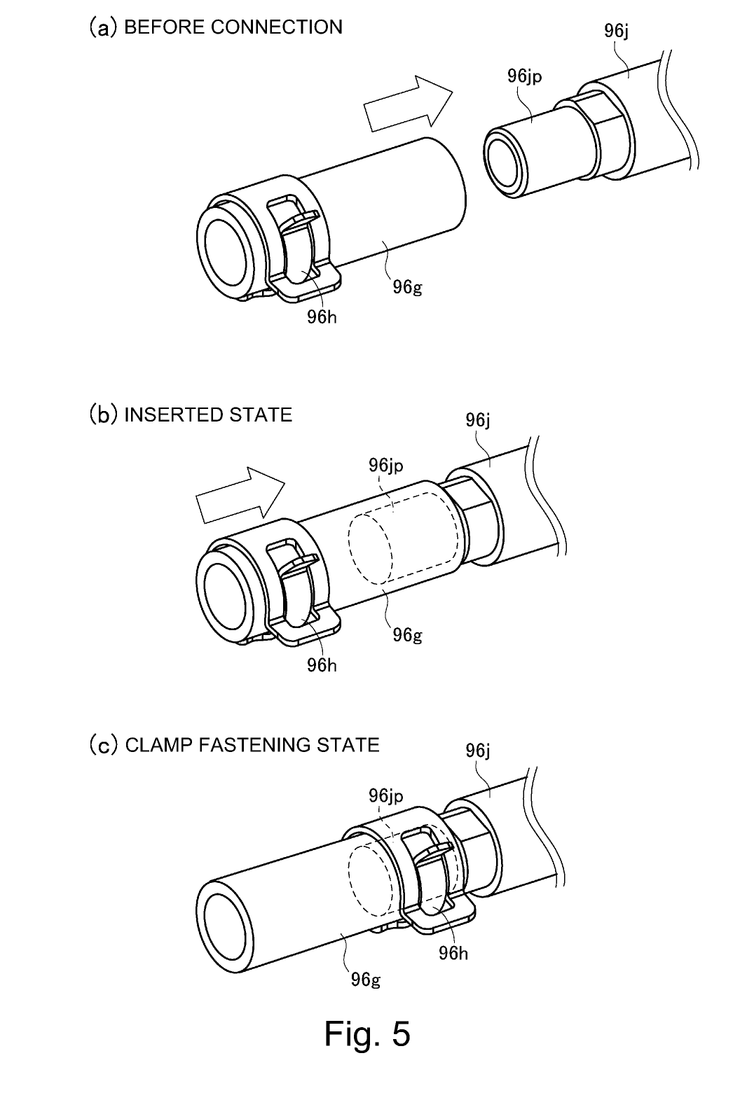

FIG. 4 is an illustration of an arrangement of the air tube. FIG. 5 includes illustrations of an air tube mounting structure. As shown in FIG. 4, in the image forming apparatus 100, a casing of a compressor unit 80 separable from a main assembly casing in which the fixing device 9 is mounted is provided. The image forming apparatus 100 which is an example of a first casing accommodates the air nozzle 93a and the solenoid valve 96e. The compressor unit 80 which is an example of a second casing is detachably mountable to the image forming apparatus 100 and accommodates the compressor 96a and the pressure adjusting valve 96c. The casing of the compressor unit 80 is partitioned by a partition wall 98 into a space in the compressor 96a side and a space in the air filter 96d side.

To the partition wall 98, the joint part 96j for relaying piping of the high-pressure air path 96 is fixed. The joint part 96j is fixed to the partition wall 98 and relays the supply of the high-pressure air supplied from the compressor 96a. A cylindrical portion 96jp is a connected portion of the high-pressure air path 96 with the joint part 96j. The joint part 96j and the air filter 96d is connected by the air tube 96g. An end portion of the air tube 96g formed with a silicone rubber is fit on the cylindrical portion 96jp, formed of alumina, of the joint part 96j. The end portion of the air tube 96g is fixed to the joint part 96j by fastening (clamping) an outside (portion) of the air tube 96g with a tube clamp 96h. The tube clamp 96h is of a leaf spring type, and increases in inner diameter by pressing both end grips in an approaching direction and decreases in inner diameter by releasing the pressure application of the both end grips thereby to fasten the air tube 96g.

As shown in FIG. 5, the air tube 96g is fixed to the cylindrical portion 96jp of the joint part 96j in the following procedure.

(1) An operator fits the tube clamp 96h on the air tube 96g at a position somewhat remote from the end portion of the air tube 96g is advance. The tube clamp 96h is of the leaf spring type, and when the grip portions of the tube clamp 96h are caught using a tool such as a long-nose plier, the inner diameter of the tube clamp 96h is enlarged, so that the tube clamp 96h is slidable in an axial direction.
(2) The operator fits the air tube 96g on the cylindrical portion 96jp and pushes the air tube 96g to a predetermined position.
(3) The operator slides the tube clamp 96h along the air tube 96g in a state in which the inner diameter of the tube clamp 96h is enlarged, and positions the tube clamp 96h at an engaging portion with the cylindrical portion 97jp.
(4) The operator releases the pressure application to the grip portions of the tube clamp 96h. By this, the inner diameter of the tube clamp 96h decreases, and a fastening force acts on the air tube 96g, so that the air tube 96g is fixed to the cylindrical portion 96jp.

As shown in FIG. 4, also a connected portion between the air tube 96 and the air filter 96d is fixed using a similar constitution. An opposite end portion of the air tube 96g from the joint part 96j is fit on a cylindrical portion 96dp, formed of aluminum, of the air filter 96d, and the outside of the air tube 96g is fastened (clamped) by a tube clamp 96n.

As shown in FIG. 4, in the high-pressure air path 96, also between pneumatic (air pressure) elements other than between the joint part 96j and the air filter 96d, connection is made similarly using air tubes 960, 96p, 96q and 96r.

### Problem of High-Pressure Air Path

As shown in FIG. 3, in the case where the high-pressure air for separating the recording material P from the fixing roller 91 is generated by the air compressor 96a, the pressure in the high-pressure air path 96 is maintained at an operating pressure (first pressure) by the pressure adjusting valve 96c. For this reason, the air tube 96g of the high-pressure air path 96 is not unclamped (and does not fall off) from the cylindrical portions 96jp and 96dp due to an internal pressure of the air tube 96g by which the fastening forces of the tube clamps 96h and 96n are overpowered.

However, in the case where the pressure adjusting valve 96c causes clogging, there is a possibility that the pressure in the air tube 96g exceeds the pressure P2 and increases up to a maximum discharge pressure P1 of the compressor 96a. When the internal pressure of the air tube 96g increases, the tube clamps 96h and 96n cannot withstand the internal pressure of the air tube 96g. The air tube 96g floats from the cylindrical portions 96jp and 96dp by the pressure, so that there is a possibility that the air tube 96g is unclamped (and falls off) from one of the cylindrical portions 96jp and 96dp.

Further, in the high-pressure air path 96, also between devices other than between the joint part 96j and the air filter 96d, connection is made similarly using the air tubes 96o, 96p, 96q and 96r, and therefore there is a possibility that also at any connected portion, the air tube is unclamped. A phenomenon that the air tube is unclamped by the internal pressure can generate at all of places of the high-pressure air path 96.

When the air tube is unclamped by the internal pressure, in order to check that which end portion of which air tube in the high-pressure air path is unclamped, it is required that all of the connected portions of the high-pressure air path 96 are checked thoroughly. When all of the connected portions of the high-pressure air path 96 are checked thoroughly, it takes time to identify the cause, so that a device recovery maintenance property by a service person becomes poor.

Therefore, in this embodiment, the pressure at which one end portion of the air tube 96g connected with the joint part 96j is unclamped at the connected portion is intentionally made smaller by 20% or more compared with the pressure at which all of other air tubes are unclamped at the connected portions. By this, when the pressure adjusting valve 96c clogs and the pressure in the high-pressure air path 96 increases, the air tube is unclamped only at one connected portion low in unclamping pressure, so that the pressure in the high-pressure air path 96 is released, and therefore, further pressure increase of the high-pressure air path 96 is prevented.

A plurality of connected portions (air tube clamped portions) in the high-pressure air path 96 includes at least one tube connected portion where the end portion of the air tube is fit on a tubular portion provided at a connected end of the connected portion and is externally fastened by a tube-like clamp which is an example of a fastening member. Further, when a discharge pressure of the compressor 96a is P1, the first pressure P2, and the pressure, in the high-pressure air path 96, at which the end portion of the air tube 96g is unclamped from the cylindrical portion 96jp at one tube connected portion is P3, P1>P3>P2 holds. All of the connected portions, in the high-pressure air path 96, other than the one tube connected portion are constituted so as to withstand static pressure larger than P3 by 20% or more.

### Experimental Result

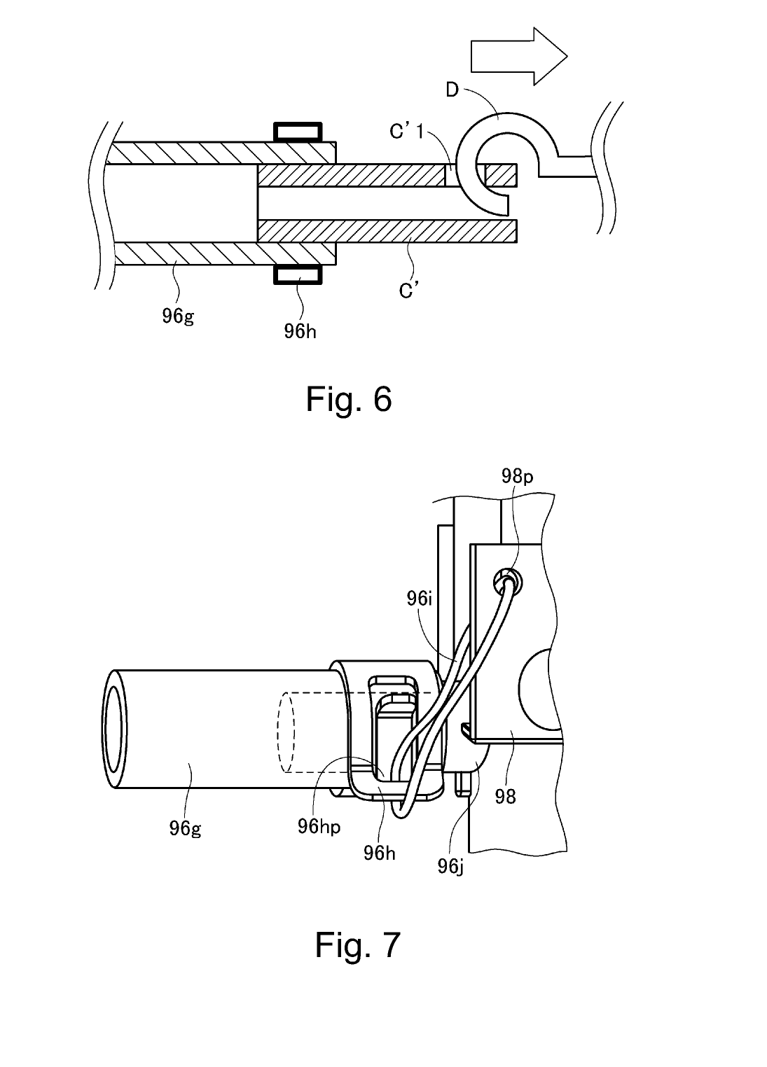

FIG. 6 is an illustration of an unclamping strength test of the air tube. In Embodiment 1, the unclamping pressure of the connected portion in the joint part 96j side of the air tube 96g connecting the joint part 96j for relaying piping and the air filter 96d was set so as to be lower than that of the connected portion in the air filter 96d side by 20% or more.

The air tube 96g is prepared by cutting a tube material of about 15 mm in outer diameter, about 9 mm in inner diameter and formed of a silicone rubber, into a necessary length. The cylindrical portion 96jp, of the joint part 96, to which one end of the air tube 96g is connected, is formed to have a smooth peripheral surface free from unevenness and an outer diameter of about 8.5 mm. The cylindrical portion 96dp, of the air filter 96d, to which the other end of the air tube 96g is connected, is formed to have a smooth peripheral surface free from unevenness and an outer diameter of about 9.5 mm.

As shown in FIG. 4, the air tubes 96o, 96p, 96q and 96r provided between the devices other than between the joint part 96j and the air filter 96d were prepared by cutting the same materials as that of the air tube 96g into necessary lengths, respectively. Both end portions of each of the air tubes 96o, 96p, 96q and 96r are constituted similarly as the connected portions of the air tube 96g and the air filter 96d, and similar unclamping pressure is set, and the both end portions were connected to corresponding pneumatic elements.

The clamps 96h and 96n of the leaf spring type are about 13 mm in inner diameter when the pressure application to the grip portions is released, and are about 16 mm in maximum inner diameter when the grip portions are pressed.

The inner diameter of 9 mm of the air tube 96g exceeds the outer diameter of 8.5 mm of the cylindrical portion 96jp to be connected. However, by fastening the outer periphery of the air tube 96g with the tube clamp 96h, the high-pressure air is prevented from leaking out from a gap between the air tube 96g and the cylindrical portion 96jp.

Insertion lengths of the air tube 96g into the cylindrical portion, 96jp and 96dp are each about 12 mm, and also widths of the tube clamps 96h and 96n with respect to an insertion direction are about 12 mm.

As shown in FIG. 6, a sample which reproduces a connection state of the air tube 96g at both end portions was prepared, and the unclamping strength was compared by a tensile test.

A test cylindrical member C′ is formed of the same material as the cylindrical portion 96jp which is a connection destination of the air tube 96g and is 8.5 mm in outer diameter which is the same as that of the cylindrical portion 96jp, and a through hole C′1 for locking a hook portion D of a digital force gage is formed.

An end portion of the test cylindrical member C′ is inserted into the air tube 96g, and an end portion of the test cylindrical member C′ in a side opposite from the air tube 96g is fixed by an unshown fixing means. Then, from a state in which the tube clamp 96h is mounted and a fastening force is exerted on the air tube 96g and the cylindrical member C′, the hook portion D pulls the cylindrical member C′ in an arrow direction via the digital force gage. A maximum load measured by the digital force gage in a process in which the tube clamp 96h is unclamped is regarded as the unclamping strength of the air tube 96g.

Another test cylindrical member C′ is formed of the same material as the cylindrical portion 96dp which is a connection destination of the air tube 96g and is 9.5 mm in outer diameter which is the same as that of the cylindrical portion 96dp. Also with regard to another test cylindrical member C′, a similar test was conducted and the unclamping strength was obtained.

TABLE 1

| COD*¹ | DS*² | DSP*³ |
|---|---|---|
| 8.5 mm | 76-89N | 0.8 MPa |
| 9.5 mm | 118-146N | 1.4 MPa |

*¹“COD” is the cylindrical portion outer diameter.
*²“DS” is the unclamping strength.
*³“DSP” is the unclamping static pressure.

As shown in Table 1, in the case where the outer diameter of the cylindrical portion 96jp is 9.5 mm, the unclamping strength of the air tube 96g was 67-89 N (6.7-8.9 kgf). On the other hand, in the case where the cylindrical portion 96dp is 9.5 mm, the unclamping strength of the air tube 96g was 119-146 N (11.9-14.6 kgf).

The unclamping strength somewhat varies also depending of difference among individuals of the air tube 96g, the cylindrical portion 96jp and the tube clamp 96h. However, as a result that a repetitive test of 10 times was conducted using the same material, a variation of the unclamping strength from an average of measured values was about 14% at the maximum.

In the case where this result is applied to Embodiment 1, when the unclamping strength at the cylindrical portion 96jp of 8.5 mm in outer diameter is converted into a piping internal pressure, the internal pressure is about 0.57-0.63 MPa. Accordingly, even when the pressure adjusting valve 96c clogs and the pressure of the high-pressure air in the high-pressure air path 96 becomes high, one end portion of the air tube 96g is unclamped at the pressure P3=0.57-0.63 MPa lower than the maximum discharge pressure P1=1.5 MPa of the compressor. The high-pressure air is discharged to the outside air from the cylindrical portion 96jp from which one end portion of the air tube 96g is unclamped, so that further pressure rise in the high-pressure air path 96 is avoided.

Further, the unclamping strength of 67-89 N at the cylindrical portion 96jp of 8.5 mm in outer diameter and the unclamping strength of 119-146 N at the cylindrical portion 96dp of 9.5 mm in outer diameter provide a difference of 20% or more even when a maximum of the former and a minimum of the latter are compared. For this reason, also the pressure difference between the cylindrical portion 96jp of 8.5 mm in outer diameter and the cylindrical portion 96dp of 9.5 mm in outer diameter is 20% or more. For this reason, the air tube 96g is unclamped at the cylindrical portion 96jp prior to the cylindrical portion 96dp without causing unclamping movement thereof at the cylindrical portion 96dp. (119−89)/89=33%>20%

In Embodiment 1, the unclamping strength of one end portion of the air tube 96g is made smaller than the unclamping strength of the other end portion of the air tube 96g, and therefore, one end portion of the air tube 96g is unclamped early during the pressure rise in the high-pressure air path. Further, connection of the end portions of other air tubes is constituted in the same manner as that of the other end portion of the air tube 96g, and therefore, of the end portions of all of the air tubes, the other end portion of the air tube 96g is first unclamped.

In Embodiment 1, the connected portion of the one end portion of the air tube 96g intentionally weaken in unclamping strength is used as a mechanical fuse for releasing the high-pressure air before the pressure of the high-pressure air generated by the air compressor 96a reaches the maximum pressure P1. The connecting position of the one end portion of the air tube 96g is determined in advance, and therefore a maintenance property during a recovery operation by a service person becomes good.

Incidentally, the end portion of the air tube for which the unclamping pressure is set at a small value is not limited to the connected portion with the joint part 96j. The end portion may also be any place such that the internal pressure in the high-pressure air path 96 exceeds the pressure P2 and a problem arises. However, in the case where protection requiring parts such as an electric substrate are provided in the neighborhood of the piping of the high-pressure air path 96, it is desirable that movement of the air tube after the unclamping and leaping-off of the clamp 96h have no influence on these parts. For example, as shown in FIG. 4, a driver substrate E of the air compressor 96a exists in the neighborhood of the high-pressure air path 96. Therefore, in Embodiment 1, the air tube 96g is mounted to the joint part 96j partitioned from the driver substrate E by the partition wall (partition) 98. By doing so, even in the case where a band member 96i is broken, the driver substrate E can be protected from the leaping-off of the tube clamp 96h.

### Leaping-Off Prevention of Tube Clamp

FIG. 7 is an illustration of a retaining member for the tube clamp. As shown in FIG. 3, during pressure rise of the high-pressure air in the high-pressure air path, in the case where the air tube 96g is unclamped vigorously from the cylindrical portion 96jp, there is a possibility that the tube clamp 96h leaps off with the vigor. At this time, there is a possibility that the tube clamp 96h which leaped off runs against a peripheral part and is broken or gets mixed in between devices on a circuit substrate and thus cannot be found.

For this reason, as shown in FIG. 7, the band member 96i which is a flexible retaining member is connected to the tube clamp 96h. The band member 96i has a length in which the unclamping of the air tube 96g at the cylindrical portion 96jp cannot be prevented, and a free end thereof is retained by the tube clamp 96h. The band member 96i connects a through hole 96hp provided in the tube clamp 96h and a through hole 98h of the partition wall 98 fixed to a destination joint part 96j for the air tube 96g. By this, even when the high-pressure air path 96 is in a high-pressure state and the air tube 96g is unclamped, a leaping-off range of the clamp 96h is limited and thus is readily found.

### Numerical Value of 20%

Incidentally, even when all of the tube connected portions in the high-pressure air path 96 have the same specification, in relative comparison, one tube connected portion lowest in unclamping pressure exists. In this state, when the pressure in the high-pressure air path 96 exceeds an allowable pressure (second pressure P4), a plurality of tube connected portions start to be unclamped in a simultaneous process. Further, even when the tube connected portion lowest in unclamping pressure is unclamped prior to other tube connected portions, some of other tube connected portions is likely to be unclamped halfway in some cases. In this case, when the unclamped two connected portion is restored, the tube connected portion lowest in unclamping pressure is switched to the tube connected portion likely to be unclamped halfway.

Further, even when all of the tube connected portions in the high-pressure air path 96 have the same specification, the unclamping pressure fluctuates due to a pressure difference, a temperature difference, the presence or absence of vibration for each of the tube connected portions, differences in direction of the air tube and tensile direction, and the like. For that reason, in Embodiment 1, the difference of 20% or more evaluated in the pulling-off test shown in FIG. 6 is provided between one tube connected portion and all of other tube connected portions. Further, it was confirmed that the one tube connected portion is unclamped prior to other tube connected portions by artificially increasing the pressure in a normal temperature (20° C.) environment by providing the difference of 20% or more evaluated in the pulling-off test shown in FIG. 6. Further, it was confirmed that all of other tube connected portions are subjected to visual inspection at the time of unclamping and there is no progress of the unclamping of each of other tube connected portions. For this reason, it would be considered that when the unclamped one tube connected portion is reconnected as before, there is no case that other tube connected portions are liable to be unclamped. Further, the unclamping order of the plurality of tube connected portions in the temperature rising process results from a relative difference in unclamping strength among the respective connected portions, and therefore, even when the environment changes to a low temperature (10° C.) environment or a high temperature (35° C.) environment, it would be considered that the one tube connected portion is unclamped prior to other tube connected portions in the pressure rising process.

Further, an experiment in which the pressure in the high-pressure air path 96 is artificially increased in a rest state of the image forming apparatus 100 was conducted, so that a relationship between the pulling-off force evaluated in the pulling-off test shown in FIG. 6 and the unclamping pressure which is pressure in the high-pressure air path 96 when the tube connected portion is unclamped was checked. As a result, it turned out that two tube connected portions different in pulling-off force evaluated in the pulling-off test shown in FIG. 6 by 20% also provide a difference of almost 20% in pulling-off pressure.

The plurality of connected portions in the high-pressure air path 96 includes two or more tube connected portions excluding the one tube connected portion. Other than the evaluation by the static pneumatic pressure application, also by the unclamping force when the tube connected portion is pulled in a direction along the cylindrical portion 96jp in a state in which the pressures in the inside and the outside of the cylindrical portion 96jp are the atmospheric pressure, the tube connected portion can be evaluated. When this evaluation is performed, in Embodiment 1, the smallest unclamping force of those of two or more tube connected portions is 20% or more larger than the unclamping force of the one tube connected portion designed so as to be unclamped.

### Effect of Embodiment 1

In Embodiment 1, a relationship of P1>P3>P2 is set among the pressure P2 adjusted by the pressure adjusting valve 96c, the unclamping pressure P3 at the predetermined one end portion and the maximum discharge pressure P1. For this reason, at the time when the pressure adjusting valve 96c clogs and the internal pressure of the high-pressure air path 96 exceeds P2 and reaches P3, the predetermined one end portion is unclamped to discharge the high-pressure air to the outside, so that further pressure rise can be avoided.

In Embodiment 1, at the predetermined one portion of the end portions of the plurality of air tubes, the unclamping pressure is set at a value smaller than those at any of other end portions by 20% or more. For this reason, when the pressure in the high-pressure air path 96 increases, the predetermined one end portion is unclamped prior to other end portions with reliability. For this reason, the unclamping air tube end portion is identified from the beginning and finding of the unclamped portion by the service person becomes early, and cause analysis is easy, so that a maintenance property during a recovery operation is satisfactorily maintained. In the fixing device in which the separation of the recording material is assisted using the compressed air, it becomes possible to improve the maintenance property during restoration of the device.

In Embodiment 1, one connected portion low in pressure resistance is unclamped prior to other connected portions, so that at many connected portions other than the one end portion low in pressure resistance, any of trace, change and lowering in pressure resistance are not caused. For this reason, also during the pressure rise after the unclamping of the air tube 96g is recovered, the air tube is unclamped at the cylindrical portion 96jp prior to other connected portions.

In Embodiment 1, the cylindrical portion 96jp is smaller in diameter than other tubular portions in the high-pressure air path 96. For this reason, a decrease in unclamping force at the cylindrical portion 96jp can be realized using the same air tube and the same tube clamp 96h.

In Embodiment 1, the air tube is a silicone rubber tube, and therefore, even when the air tube is used for a long term, the air tube is unclamped with high reproducibility to the pressure without sticking to the cylindrical portion 96jp. Further, the material is soft, and therefore, the unclamping force is easily controlled by a magnitude of the clamping force of the tube clamp.

In Embodiment 1, the partition wall 98 partitions the inside of the compressor unit into the space where the compressor 96a is disposed and the space where the cylindrical portion 96jp is disposed. For this reason, the tube clamp 96h and the air tube 96g which are unclamped from the cylindrical portion 96jp cannot enter the space where the compressor 96a is disposed.

### Embodiment 2

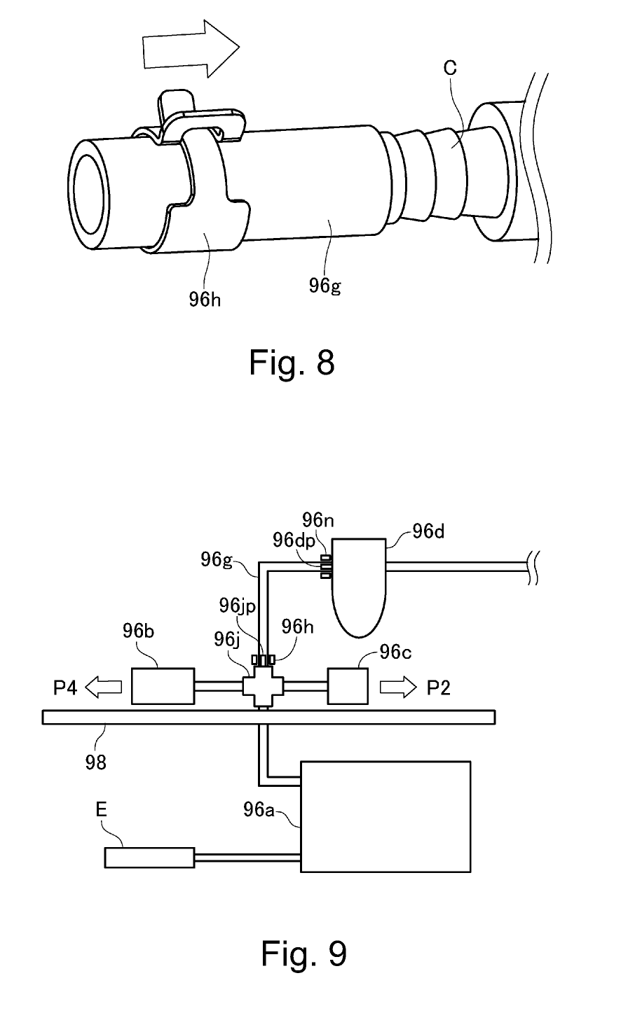

FIG. 8 is an illustration of an air tube connected portion in Embodiment 2. As shown in FIG. 8, Embodiment 2 is constituted similarly as Embodiment 1 except that the cylindrical portion 96dp in which the air tube 96g is inserted is provided with a constriction. For this reason, in FIG. 8, constitutions in common with Embodiment 1 are represented by common symbols and will be omitted from redundant description.

As shown in FIG. 5, in Embodiment 1, all of the tubular portions which are destinations of the air tube connected portions have a straight cylindrical shape, and at a preliminarily selected one tube connected portion, the diameter of the tubular portion was made smaller than those of other tube connected portions, so that the difference in unclamping pressure was set. On the other hand, in Embodiment 2, the tubular portion has the straight cylindrical shape at the preliminarily selected one tube connected portion, and at all of other tube connected portions, an outer appearance of the destination tubular portion had a so-called volute (bamboo shoot) type having a ring-shaped unevenness. That is, at the destination tubular portion, a stepped portion functioning as a retainer for the air tube 96g was provided.

In Embodiment 2, the cylindrical portion 96jp is straight in shape, and other tubular portions are provided with the ring-shaped unevenness. For this reason, a decrease in unclamping force at the cylindrical portion 96jp can be realized using the same air tube and the same clamp 96h.

### Embodiment 3

As shown in FIG. 5, a difference in unclamping force was set by a magnitude of a fastening force of the tube clamp. At preliminarily selected one tube connected portion, an inner diameter dimension of the clamp 96h was made larger than those of other tube connected portions, so that the fastening force for the air tube 96g was made small and thus the unclamping strength was adjusted.

In Embodiment 3, the tube clamp 96h used at the cylindrical portion 96jp is smaller in fastening force than the tube clamps used at other the ring-shaped portions. For this reason, a decrease in unclamping force at the cylindrical portion 96jp can be realized using the same tubular portion and the same air tube.

### Embodiment 4

FIG. 9 is an illustration of a high-pressure air path in Embodiment 4. As shown in FIG. 4, in Embodiment 1, the unclamping force of the air tube 96g is decreased only at the connected portion between the joint part 96j and the air tube 96g, and the connected portion was used as the mechanical fuse. On the other hand, as shown in FIG. 9, in Embodiment 4, in addition to the connected portion between the joint part 96j and the air tube 96g, also the pressure-heating solenoid valve 96b was used as the mechanical fuse for releasing the compressed air. As a result, safety is further enhanced against the unclamping of the air tube 96g.

As described above, the pressure-heating solenoid valve 96b discharges the high-pressure air, in the high-pressure air path 96, to the outside. The controller 99 actuates the pressure-heating solenoid valve 96b during actuation of the compressor 96a and lowers the pressure in the high-pressure air path 96 to atmospheric pressure, so that an actuating torque of the compressor 96a is decreased to a small value.

In addition to this, the pressure-heating solenoid valve 96b is mechanically actuated when the pressure in the high-pressure air path 96 reaches the allowable pressure (second pressure P4), and lowers the pressure in the high-pressure air path to the atmospheric pressure. With no electrical signal, the pressure-heating solenoid valve 96b is actuated only by reacting with the pressure of the high-pressure air in the joint part 96j.

The pressure-heating solenoid valve 96b which is an example of the pressure releasing valve is connected with the high-pressure air path 96 and communicates with the ambient air when the pressure in the high-pressure air path 96 reaches the second pressure P4, and thus regulates the pressure in the high-pressure air path 96. The pressure-heating solenoid valve 96b (SMC Corporation, VX-240 DA) is a solenoid valve of a type in which the solenoid valve is closed during energization and is open during non-energization, and releases the compressed air remaining inside the piping after the compressor 96a is at rest. When a pressure difference between a primary side and a secondary side of the valve exceeds a maximum operating pressure difference, the pressure-heating solenoid valve 96b is forcedly placed in a valve open state. By using this, for example, as the pressure-heating solenoid valve 96b, a pressure-heating solenoid valve 96b of 0.4-0.5 MPa in maximum operating pressure difference can be used. By this, even when the pressure in the high-pressure air path 96 increases due to a malfunction of the air compressor 96a and the pressure adjusting valve 96c, at the time when a pressure value reaches 0.4-0.5 MPa, the pressure-heating solenoid valve 96b opens, so that the compressed air is released. Further, the pressure value of 0.4-0.5 MPa at this time is made smaller than a pressure value at which the clamp 96h is unclamped at the tube connected portion lowest in unclamping strength. For this reason, when the inner pressure of the piping increases, first, a safety mechanism of the pressure-heating solenoid valve 96b acts first, so that the compressed air is released. By this, when the second pressure is P4, P1>P3>P4>P2 holds. Accordingly, a possibility that the state of the clamp 96h reaches a leaping-off state can be further lowered, so that the safety can be further enhanced.

### Other Embodiments

In Embodiment 1, as shown in FIG. 4, the compressor unit 80 was provided independently of the main assembly casing of the image forming apparatus 100 in which the fixing device 9 was mounted. However, the compressor 96a and the high-pressure air path 96 which are accommodated in the compressor unit 80 may also be provided in the main assembly casing of the image forming apparatus 100 in which the fixing device 9 is mounted. Or, the compressor 96a and the high-pressure air path 96 may also be accommodated by providing a casing of the fixing device independent of the main assembly casing of the image forming apparatus 100.

In Embodiment 1, of the pair of rotatable members for forming the nip for carrying out the fixing process, one used the roller member and the other used the endless belt, but a combination of the pair of rotatable members is not limited to the combination of the roller member and the endless belt. The combination of the pair of rotatable members may also be combinations of the heating roller and the pressing roller, the heating belt and the pressing roller, and the heating belt and the pressing belt.

The air tubes are not required that all of the air tubes are flexible, that all of the air tubes are silicone rubber tubes and that all of the air tubes have the same diameter and the same thickness. The air tubes may only be required that at least one air tube is lower in unclamping pressure at one end than at the other end, and may only be required that the pressure resistance at the other connected portion in the high-pressure air path 96 is higher than the unclamping pressure at one end.

### INDUSTRIAL APPLICABILITY

According to the present invention, there is provided the image heating apparatus in which a time required for the recovery operation is shortened.

1. An image heating apparatus comprising:
first and second rotatable members for forming a nip for heating a toner image on a sheet;
a compressor;
an air nozzle for blowing air, generated by said compressor, on said first rotatable member; and
a supplying mechanism for supplying air from said compressor to said air nozzle, said supplying mechanism including a plurality of air tubes and a plurality of clamps for fixing said plurality of air tubes,
wherein a pressure at which the air tube is unclamped is lower only at a predetermined portion of the clamped portions than the other portions by 20% or more.

2. An image heating apparatus according to claim 1, wherein said supplying mechanism includes a plurality of relay members each provided between adjacent air tubes, and of the clamped portions, a diameter of a portion of an associated relay member into which an associated air tube is inserted is smaller only at the predetermined portion than at other portions.

3. An image heating apparatus according to claim 1, wherein said supplying mechanism includes a plurality of relay members each provided between adjacent air tubes, and of the clamped portions, a force for fastening an associated air tube to an associated relay member by an associated clamp is smaller only at the predetermined portion than at other portions.

4. An image heating apparatus according to claim 1, wherein said supplying mechanism includes a pressure limiting mechanism for limiting a pressure of the air to a predetermined pressure or less, and at the predetermined portion, the pressure at which the air tube is unclamped is higher than the predetermined pressure.

5. An image heating apparatus according to claim 4, wherein said pressure limiting mechanism includes a pressure releasing valve.

6. An image heating apparatus according to claim 1, wherein of the clamped portions, only at the predetermined portion, said clamp is fastened.

7. An image heating apparatus according to claim 1, further comprising a partition for partitioning an inside of said image heating apparatus into a space where said compressor is provided and a space where the predetermined portion is provided.
